(19) United States
(12) Patent Application Publication
(10) Pub. No.: US 2006/0084417 A1
(43) Pub. Date: Apr. 20, 2006

(54) Interface selection from multiple networks

(76) Inventors: Diego Melpignano, Monza (IT); David Siorpaes, Cortina D'Ampezzo (IT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/520,389

(22) PCT Filed: Jun. 25, 2003
(86) PCT No.: PCT/IB03/02888

§ 371 Date: Jan. 4, 2005

(30) Foreign Application Priority Data
Jul. 10, 2002 (EP) 0201.5345.8

(51) Int. Cl. H04M 3/00

(52) U.S. Cl. 455/418

(57) ABSTRACT

An arrangement is disclosed that enables a mobile device to manage multiple network interfaces in order to be substantially always reachable on the Internet. Wired LAN, Wireless LAN, Wireless PAN and cellular systems are technologies that are employed in the exemplary embodiment described. Scanning of the available network infrastructures is performed by a specific software agent implemented in a mobile device. User mobility profiles, power consumption, cached context information and application requirements are taken into account so that the end user can always communicate through the most appropriate network interface without explicit manual intervention.

The present invention relates to interface selection from multiple networks, especially wireless networks, and in particular, but not exclusively, to interface selection by a mobile device from among a plurality of networks, especially wireless networks, that may be periodically available at least temporarily in a communications system.

Wireless local area networks (WLAN) are becoming popular nowadays, not only in indoor environments but also in outdoor spaces. By means of wireless access points, mobile/client devices can use networking services without a wired connection in similar fashion to use of a wired LAN. General information on wireless LAN protocols and systems may be found in “Wireless LANs”, by Jim Geier, Macmillan Technical press, 1999. One problem with WLAN is power consumption, which can become an issue for portable devices like a personal digital assistant (PDA). Wireless Personal Area Network (WPAN) technologies like Bluetooth™ can offer wireless network connectivity at a lower bandwidth but with significantly reduced power consumption. When neither WLAN nor WPAN access infrastructure is available, a mobile device would require a functionality which allows it to use other wireless systems, if available, e.g. outdoor cellular systems like General Purpose Packet Radio System (GPRS) to generate a new connection or possibly to stay connected with the Internet or with a corporate intranet. If properly adapted, the same mobile device could be plugged into a wired LAN when put into its docking station when coming back to office. At this point, the device may well be stationary, but it will be appreciated that it may still be considered a mobile device in reflection of portability or facility to change location.

The mobile device should therefore have multiple network interfaces available, at least temporarily, that provide connectivity in a variety of contexts. Such a terminal is described as a multi-mode terminal. These interfaces could be either embedded in the device or can be manually inserted by the user, as in for example the case of plug-in cards. One device of this general type is disclosed in GB-2362237, in which a PDA has a base unit with at least a battery holder and a number of changeable modules which slot, slide or clip into the base unit. This prior art arrangement proposes a card module that Implements radio frequency (RF) circuitry, link control and baseband functions for implementing wireless links, although there is no disclosure of how a selection could be made or implemented between a plurality of network interfaces which might become available for choice from time to time.

To date, in cases where multiple options exist, there is no universal solution to automatically decide which network interface any particular device should use at a particular time. In fact, some chipset and card manufacturers are announcing proposals for combination products (“combo' chipsets”) that embed multiple wireless transmission standards and some of these already exist on the market. However, without supporting software, the user must always manually select one network interface to connect to the Internet or to a corporate Intranet. This is the case for most operating systems like Windows CE and Windows XP as supplied by Microsoft Inc. USA or Linux.

In order to use a specific wireless interface, a corresponding network infrastructure that provides access to a backbone network must be present and a discovery procedure for available networks access must be provided. This discovery process can be time and energy consuming. Even scanning for all the frequencies of one system is so power consuming that mobile terminals for cellular systems conventionally do not do this but only scan a limited number of frequencies. Scanning for a specific wireless network infrastructure (e.g. WLAN) may result in a list of usable access points to which the mobile device can connect. In case a WLAN infrastructure (as in the previous example) is not found, the WLAN interface in the mobile device cannot provide network connectivity and another one has to be investigated.

Depending on the environment in which the user finds himself, it is probable, especially in the future, that there are multiple network infrastructures available, at least temporarily. The prior art arrangements can therefore be seen to be deficient in the automation of discovering whether and which wireless network infrastructures are available and in consequently activating the proper network interfaces. This may lead to deficiencies in a mobile device meeting a user's connectivity expectations, for example in terms of cost, convenience, power consumption and bandwidth. A user of currently disclosed arrangements may therefore experience difficulty in establishing or maintaining a location independent connection to a backbone network like the Internet. This is the case with current arrangements, at least without manual intervention which may be considered as inefficient and generally undesirable.

It is an object of the present invention to provide improved network selection from multiple networks and in particular, but not exclusively, to provide improved interface selection by a mobile device from among a plurality of networks, especially wireless access networks, that may be periodically available at least temporarily in a communications environment.

An automatic network interface selection mechanism would provide benefits for the end user in terms of usability. Accordingly, the present invention provides a wireless client device for use in an Internet Protocol compatible communications network, said client device being adapted to communicate with said network in accordance with one of a plurality of communications standards and to make a selection for connection to said network from among a plurality of network interfaces, said device being arranged in use to make a said selection automatically and according to a predetermined network interface selection policy implemented in said client device. Such a device may be called a multi-mode terminal. A client device may be a user terminal such as a mobile terminal.

A said network interface selection policy may be selected for implementation by user intervention or by said client device itself from among a predefined set of said selection policies stored therein.

A said network interface selection policy may include a consideration of at least one of location or context awareness, preferably including a mobility parameter indicative of whether a said location or context is dynamic or static and/or an indication of how such information has been gathered.

Said client device may be adapted to change automatically between network interface selection policies under predetermined circumstances, authority to make a said change preferably being provided by a user and/or preferably being notified to a user.

Said client device may be adapted to test for the availability of one or more of said network interfaces, preferably by periodically performing a scan of available interfaces.

Said client device may be adapted to pre-connect to a said interface selected by a said network interface selection policy, so as to test the availability of said interface in advance of performing a handover thereto from a currently connected interface.

Said network interfaces may be controlled by a multi-standard enabled wireless adaptation layer implemented in an operating system of said client device.

A plurality of said interfaces may be assigned a priority for implementation in a said network interface selection policy, a said priority preferably being changeable in said client device and more preferably being dynamically changeable to reflect current status of said interface.

Said client device may store information relating to access points currently available and/or previously visited.

Said client device may be adapted to monitor network interface availability substantially continuously and preferably keeps updated a stored list of available said interfaces.

A switch between said interfaces may be performed by said client device in the event that a stronger or higher priority interface becomes available or in the event that a connection to a network infrastructure that uses current said interface is lost.

Said client device may be adapted to check, at least periodically, the availability of one or more access points neighboring a currently connected access point.

A said network interface selection policy may include consideration of at least one of usage cost, bandwidth availability, received signal strength, link quality, link availability, signal-to-noise ratio, power consumption or user intervention.

A said communications standard may comprise one of Ethernet, IEEE 802.11a, IEEE802.11b, Bluetooth™ GPRS and GSM data.

The present invention also provides a method of performing communication in an Internet Protocol compatible network, the method including:
a) connecting a client device to said network in accordance with one of a plurality of communications standards; and
b) changing automatically between said communications standards under predetermined circumstances defined in a network interface selection policy implemented in said client device.

The present invention also includes a computer program product for executing a method described above in accordance with the present invention when executed on a computing device. The present invention also includes a data carrier having the computer program product encoded thereon as an executable program.

### BRIEF DESCRIPTION OF THE DRAWINGS

FIG. 1 is a block diagram of a system including an arrangement according to an embodiment of the present invention;

FIG. 2 is a use case diagram for a network interface selection policy implemented in a client device of FIG. 1;

FIG. 3 is a class diagram for a network interface selection policy implemented in a client device of FIG. 1; and

FIG. 4 is a task diagram for a task manager of a network interface selection policy implemented in a client device of FIG. 1.

### DETAILED DESCRIPTION OF A PREFERRED EMBODIMENT

The present invention will now be described with reference to certain embodiments and with reference to the above mentioned drawings. Such description is by way of example only and the invention is not limited thereto. The term “comprising”, e.g. in the claims, does not exclude other elements or steps and the indefinite article “a” or “an” before a noun does not exclude a plurality of the noun unless specifically stated. With respect to several individual items, e.g. a charnel decoder, channel equalizer, or items given an individual function, e.g. a channel decoding means, channel equalizing means, the invention includes within its scope that a plurality of such items may be implemented in a single item, e.g. in a processor with relevant software application programs to carry out the function even if these items are described separately.

Where reference is made to a “client device being adapted to communicate with a network in accordance with one of a plurality of communications standards”, the skilled person will appreciate that such a device may be referred to as a multi-mode terminal. As a specific example, a multi-mode terminal may have access capabilities for any one of Ethernet, IEEE802.11a, IEEE 802.11b, Bluetooth™, GPRS and GSM.

Where the present invention refers to “standards” used in communications arrangements, such a standard may comprise a technical guideline advocated by a recognized organization, which may comprise for example a governmental authority or noncommercial organization such as the IETF, ETSI, ITU or IEEE, although not limited thereto. Standards issued or recommended by such bodies may be the result of a formal process, based for example on specifications drafted by a cooperative group or committee after often intensive study of existing methods, approaches and technological trends and developments. A proposed standard may later be ratified or approved by a recognized organization and adopted over time by consensus as products based on the standard become increasingly prevalent in the market. Such less formal setting of a “standard” may further encompass technical guidelines resulting from implementation of a product or philosophy developed by a single company or group of companies. This may particularly be the case if, through success or imitation, such guidelines become so widely used that deviation from the norm causes compatibility problems or limits marketability. The extent to which a piece of hardware conforms to an accepted standard may be considered in terms of the extent to which the hardware operates in all respects like the standard on which it is based or designed against. In reference to software, compatibility may be considered as the harmony achieved on a task-orientated level among computer elements and programs. Software compatibility to a standard may therefore also be considered the extent to which programs can work together and share data. Such a communications standard may define a wireless access protocol, which may be based on any suitable wireless access system, e.g. Frequency Division Multiple Access (FDMA), Code Division Multiple Access (CDMA), Time Division Multiple Access (TDMA), Time Division Duplex (TDD), Orthogonal Frequency Multiple Access (OFDMA) or combinations of these such as CDMA/FDMA, CDMA/FDMA/TDMA, FDMA/TDMA. As a specific example, one of IEEE 802.11b, Bluetooth and GPRS may be selected.

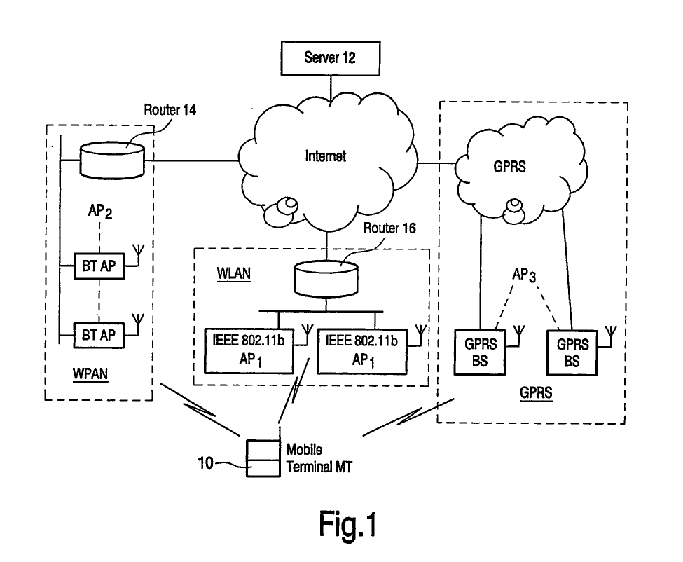

Referring to the drawings and for the moment in particular to FIG. 1, a communications network selection system 10 embedded in a client device MT provides a plurality of network interfaces for connectivity to a server 12 via the Internet or another IP-based network. The client device may be a mobile or fixed terminal providing any of data, fax, video or speech services or combinations of these such as multi-media services, e.g. of varying bandwidth. To achieve this, client devices include multimode ability so as to be able to make best use of the communications standards available. In this embodiment, a non-limited list of examples used includes an IEEE 802.11b Wireless Local Area Network (WLAN), a Bluetooth™ Wireless Personal Area Network (WPAN) and cellular system in the form of a Generalized Packet Radio System (GPRS). These client devices/nodes may include Personal Digital Assistants (PDA's), laptop computers and mobile phones or similar and, although not necessarily being moved at any particular time, will be referred to herein for convenience as mobile terminals MT so as to reflect a possibility of portability.

The node through which access to the network is achieved will be referred to for convenience generically as an access point AP, although it will be appreciated that the form of an access point AP will depend on the access technology under consideration. IEEE 802.11b has its own access points AP₁ as does Bluetooth AP₂, whereas the access points AP₃ for GPRS may be referred to in the art as base stations BS. The Bluetooth access points AP₂ may connect through a dedicated router 14, while a further router 16 may be provided for WLAN access via the IEEE 802.1 b access points AP₁.

The present invention provides an arrangement in which network interfaces in a client device may be selected automatically according to user-defined policies whenever a mobile terminal MT has multiple choices available. These policies may take several factors into account including data transfer speed, power consumption, user mobility profiles, cached context information, security authorizations and connection costs.

The user may select one network interface selection policy (NISP) among a predefined set or define its own new NISP. Once a policy is selected, the mobile device will use the preferred network interface (provided it is available) and will periodically scan for other usable network infrastructures. In this way, when the interface with the highest priority is no longer usable (either because there is no wireless coverage or because the user has undocked its mobile terminal or removed the card), a new network interface is ready to be activated and the user keeps its network connectivity.

A NISP may be associated with a specific location and context. The mobile terminal (MT) can switch among different NISPs either automatically (for example when a known wireless network infrastructure is recognized and a specific location can be inferred) or by means of explicit user intervention. Further details of an NISP and its main characteristics are given below.

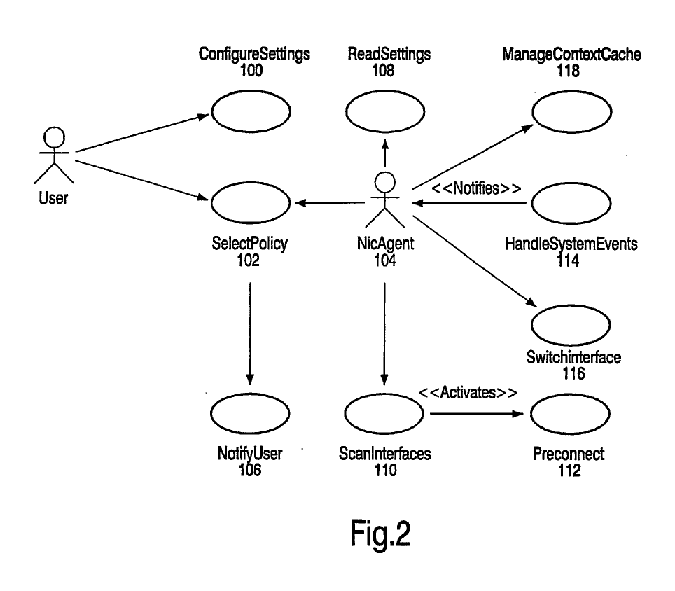

The diagram depicted in FIG. 2 shows the main use cases for the network interface management solution described in the present invention, using standard Unified Modeling Language (UML) notation.

The user indicates his/her preferences in the “ConfigureSettings” 100 use case: this can be a GUI (graphical user interface) tool where a set of NISPs can be defined and other settings specified as well. “SelectPolicy” 102 activates one specific NISP and it can be invoked either manually by the user or by a software agent, i.e. NicAgent 104, which is a software daemon that supervises the whole network selection system 10 in the mobile terminal MT. The NicAgent 104 may decide to change policy, if the user has allowed this behavior in the configuration settings of the device. Whenever a policy is changed, the user may receive a notification through the GUI (“NotifyUser” 106), if appropriate. Based on the settings defined by the user, which are read (“ReadSettings” 108) upon systems initialization or upon a change in the settings themselves, the NicAgent 104 periodically probes the available network interfaces (“ScanInterfaces” 110).

This “ScanInterfaces” 110 use case includes testing the physical availability of the network interface, checking its status and verifying that it can actually provide connectivity. When a wireless infrastructure is found and the policy allows it, the system 10 tries to connect to it to check if the link is usable and to keep its network connections (“Preconnect” 112). This may include, in the example case of a Bluetooth infrastructure, inquiring for access points AP₂, connecting to them and performing service discovery and authorization procedures, as specified in the Personal Area Network (PAN) profile or in the LAN access profile.

It should be noted that in this context the Access Point role can also be implemented by a mobile phone with Bluetooth and GPRS interfaces (Bluetooth Dial-up Networking profile), or by a Bluetooth enabled laptop that also has an Ethernet connection.

Based on the outcome of the preconnection case 112 or resulting from other user's actions (e.g. a network card is physically removed from the mobile terminal MT or an Ethernet cable is physically (dis)connected (from)to the MT), some events may be generated (“HandleSystemEvents” 114), which are then passed to the NicAgent 104. These events may include:

infrastructure exists and is usable;

infrastructure exists but the mobile terminal MT does not have access rights;

a new interface card/network cable has been inserted; and

an interface card/network cable has been removed.

The NicAgent 104 reacts to these events according to the policy it is using at the moment. A possible outcome of these events is the activation of a new network interface card (“ActivateInterface” 1116), i.e. a handover action is started by “SwitchInterface”. A handover may include deactivating one network interface and activating a new one. Other network layer functions may be involved in this process.

Depending on the event that is generated, useful information can be gathered by the NicAgent 104, which may, for example, store it in a suitable memory such as a cache and use it to include context or location dependent network selection in the NISP used. The “ManageContextCache” 118 use case refers to the process of managing the information related to a specific environment: for example, when a local area network interface card has been plugged in, e.g. an Ethernet card, and the NicAgent 104 recognizes that the mobile terminal MT has been connected to an office network, an “office” context may be inferred. This context may include a description of other network infrastructures like Wireless LAN and/or Bluetooth that are present in the office environment. Based on this context information, a specific network interface selection policy may be activated in the mobile terminal MT and optionally notified to the user (“NotifyUser” 106).

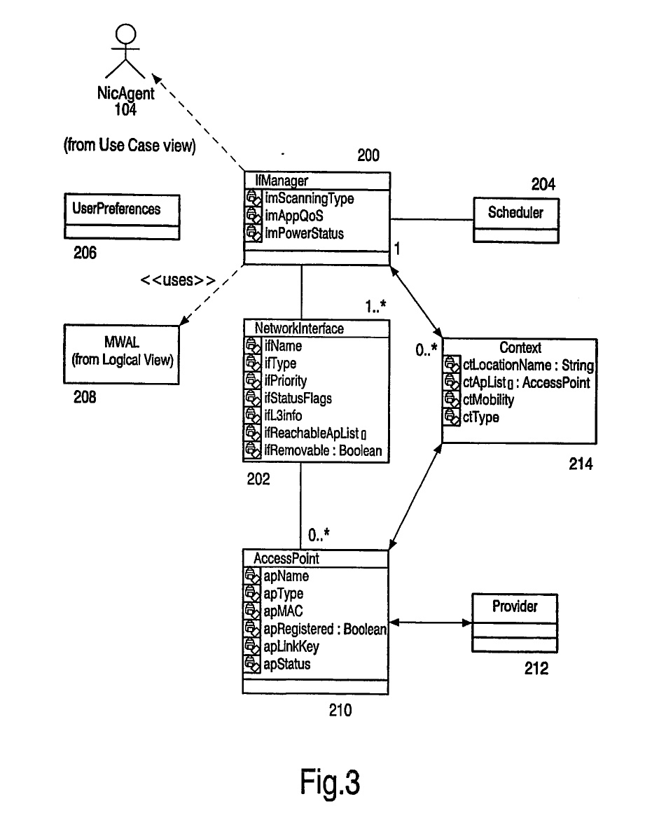

A selection of suitable main classes of an NISP-based mobile terminal MT are shown in the network interface (“if-“) class diagram of FIG. 3. The NicAgent 104 role is implemented by the IfManager class 200. The IfManager 200 uses the NetworkInterfaces class 202 and it is associated with a Scheduler 204, which is responsible for providing time services, i.e. triggers for checking a specific network interface. The UserPreferences class 206 keeps all the settings that the user can set. In order to actually control network interfaces, the IfManager 200 uses a Multistandard Wireless Adaptation Layer (MWAL) 208, which is a software module that handles all existing software device drivers for network interface cards. The MWAL 208 is linked with the operating system of the mobile terminal MT and it is allows the IfManager 200 to communicate with the device drivers of the network interface cards.

On the other hand, the NetworkInterface class 202 is a high-level representation of the actual wireless or wired network interface card. Its properties include a name (usually operating system OS dependent; “fName”), a type (WLAN, Bluetooth, GPRS or other as the case may be; “fType), a priority (“fPriority”) that can be dynamically changed by the IfManager 200 and flags (“fStatusFlags”) that represent the interface current status. Other parameters include network layer information (“fL3Info”; default gateway, IP address), the physical characteristic of the network interface (whether it is implemented as a removable card “fremoveable: Boolean” or it is embedded in the system) and a list of reachable access points AP₁₋₃.

The AccessPoint class 210 holds information about the name (“apName”) of the access point AP₁₋₃, its type (“apType”), MAC address (“apMAC”), whether it has already been visited or not (“apRegistered: Boolean”), a default link key (“apLinkKey”) to encrypt traffic and its status (“apStatus”), which is a dynamic parameter that can be set as a result of infrastructure scanning and previous use of the access point AP₁₋₃ by the mobile terminal MT. Access Points AP₁₋₃ may be shared by multiple service providers 212. Information about the back-end network, that the AP gives access to, can be stored as well, e.g. if it is an 10/100 Mbps Ethernet or a 44 kbps GPRS connection.

Finally, the Context class 214 keeps information about the environment surrounding the user, including a location name (e.g. “office” or “home”) and a list of reachable access points AP₁₋₃. A mobility index parameter is included to indicate whether the location and/or context is a dynamic one or a static one (e.g. the chance that the user moves away and enter a new context). A context type indicates how the location or context information has been gathered, that is if the location or context is defined manually, has been built automatically or has to be refreshed periodically.

The IfManager class 200 represents the actual running application that manages all other classes. At the driver's level, the MWAL Module 208 performs the unification of the various interfaces as seen by the operating system, while the IfManager application 200 is responsible for its control.

The IfManager 200 takes care of the wireless interfaces connectivity, management and selection being performed by choosing the best available interface according to context and user's preferences. IfManager 200 also guarantees that Layer-three connectivity is always maintained by performing Vertical Handover between the available interfaces when needed and consequently updating routing information. It is supposed that the mobile terminal MT is willing to reach some host in the Internet, hereafter referenced as the server 12.

The IfManager application 200 is in charge of at least the following tasks:
1. Continuous monitoring of network interface availability. Constant refreshment of the list of available hardware resources and related properties, which is needed in order to be able to switch interfaces as soon as a new and/or more preferable interface is added or made available to the mobile terminal MT or when the currently in use interface is removed. Hardware monitoring can be performed by polling periodically for the mobile terminal's hardware status or, better, by exploiting hardware insertion/removal events.
2. Access points AP₁₋₃ identification for each available network interface. Depending on the user's location, surrounding access points AP₁₋₃ may be known or unknown. Access configuration parameters of known access points AP₁₋₃ are stored locally in “context” classes 118 in the mobile terminal MT. Previously unknown access points parameters may be later discovered and cached for future use speed up. Depending on the wireless technology, access point discovery may also be performed on the basis of scanning at periodic intervals (e.g. a Bluetooth inquiry procedure) or after an asynchronous event (e.g. IEEE 802.11b WLAN wireless events). For each interface, a list of detected (reachable) access points is preferably maintained.
3. Interfaces connectivity check (“check_interface” function). Each interface may or may not have Layer-three connectivity, i.e. can or cannot reach the first router behind the access point AP₁₋₃. In order to guarantee such connectivity, the interface must have:
   a) A connectable access point. The mobile terminal's user must have the rights to connect to one or more access points AP₁₋₃ associated with the interface in question.
   b) A valid IP address. The infrastructure bearer should provide via DHCP or other means a valid IP address that allows the mobile terminal MT to reach the server 12. (These two conditions a, b have to be checked periodically.)
4. Mobile terminal MT connectivity check. The mobile terminal's communication integrity has to be checked periodically. The current interface the mobile terminal MT is relying on may be removed by the user, may move out of access point's range, or may change IP subnet. In all of these cases proper counteractions have to be taken as soon as the connectivity is broken. Using periodic pings to the first router behind the access point AP₁₋₃ (default gateway) may check connectivity integrity; its breakage may be notified by asynchronous events (hardware removal, wireless events, under-threshold signal to noise ratio and others). A “ping” procedure tests the network to see what systems are working. For this purpose one network element sends out a predetermined signal to another network element and waits for a response. The correct response indicates that the remote network element is responding and the network is in tact. A ping procedure can also test and record the response time of accessing other network elements. This can provide useful information on which network elements and/or networks are available and whether these are overloaded so access times can be optimized. The ping procedure may use the Internet Control Message Protocol (ICMP).
5. Vertical handover. Vertical handover may occur in response of two events:
   a) A better (according to user preferences) interface that allows Layer-three connectivity has been detected. The current interface is left and the new one is attached. This of course happens only if the new interface guarantees connectivity. Layer-three Connectivity tests of non-attached interfaces happen in the background.
   b) The current interface the mobile node is relying on becomes suddenly disconnected, either because of hardware removal or link disconnection or IP subnet change (it may happen that the mobile node is connected to an access point and roams to another one that belongs to a different subnet. In this case link connectivity is not broken thanks to the automatic link layer handover provided by the bearer, but IP connectivity is).

In case a) the vertical handover is said to be an “upper vertical handover” and its timings are not crucial since connectivity is not compromised. In case b) the vertical handover is said a “lower vertical handover” and its timings are much more crucial since the mobile node remains in the disconnected state until a new interface or a new access point AP 13 that allow communication re-establishment is detected.

In addition, information retrieved at points 2 and 3 is preferably cached locally in the context database/cache 118, 212 in order to recognize immediately a wireless infrastructures' properties for future use.

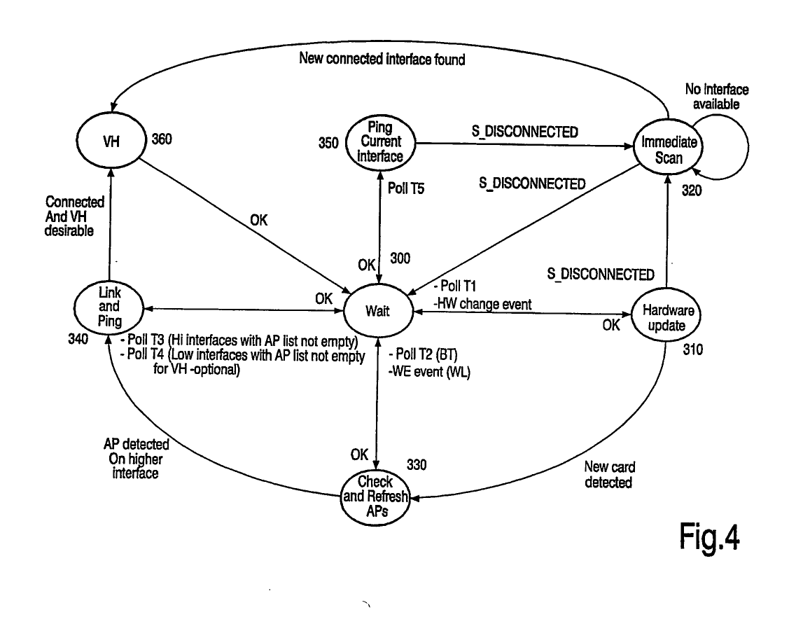

Referring now in particular to FIG. 4, a task diagram is depicted for the if Manager 200 and the events will now be discussed in detail.

Wait 300

The wait task 300 is the idle task, the one that spawns all other tasks (the main). It also performs application initialization and resource allocation when IfManager 200 is started. Wait 300 performs application clean up and resource freeing when an application is closed. The wait task 300 also initializes all timers that govern the other task timings.

Hardware Update 310

The hardware update task 310 is awakened each time its polling interval expires or when an asynchronous hardware event such as card insertion/removal occurs. Its main job is keeping up to date the list of the available network cards. Each entry of the list is a NetworkInterface class 202 described above.

As a result of new hardware insertion, the hardware update task 310 issues a signal that unlocks the task in charge of checking and refreshing an interface's access point list (see below). As a result of hardware removal, the task frees the resources that have been previously allocated and, in case the removed hardware is the same the mobile terminal MT used to connect with, the S_DISCONNECTED signal is raised. This signal triggers the “immediate scan” task 320, whose purpose is to re-establish as soon as possible Layer-three connectivity using another interface. In the event that the hardware list remains unchanged, the task is put asleep again.

Check and Refresh Access Points (APs) 330

This task 330 is responsible for checking the availability of neighboring access points AP. It does not perform any test on actual connectivity, neither at Layer-two nor at Layer-three; it just updates the access point list of a given interface. If a new access point AP is detected, a new object “AccessPoint” describing it is added to said list; if an access point belonging to the list is no longer available, its entry is freed. The task 330 sorts the access point list by “knowledge”. An access point AP could be “known”, that is the user has specified the parameters that are needed to connect to it (e.g. encryption key or encryption method) in a context class. It could be “unknown”, that is it has never been seen before. It could be “cached”, which means that it was previously unknown, but some information has been detected in the past (for example there is/there is not need for an encryption key).

Check and refresh access point task 330 is awaken whenever its poll interval expires for technologies that do not support wireless events such as Bluetooth, or it can be awaken after a “new access point” wireless event for technologies that support this feature, such as Wireless LAN. The check and refresh access point 330 is also awaken by a “new card detected” signal raised by the hardware update task.

Check and refresh access point task 330 raises a signal whenever an access point AP is detected on an interface with higher priority than the one in use. This signal is then caught by the link and ping task 340, which checks whether the new discovered access point AP can be used to connect to the server 12 or not, as discussed below in greater detail. After completing the access point scanning, the check and refresh access point task 330 returns to sleeping.

Link and Ping 340

The link and ping task 340 is responsible for checking whether an interface is able to connect to the server 12 via one or more of its access points AP₁₋₃ in the list. It is hence preferably called only for interfaces whose access point list is not empty. For a given interface, all access points AP₁₋₃ in the list are first checked for link layer connectivity, then IP configuration is checked by issuing DHCP requests, and pinging the server 12 finally checks network connectivity (for scalability reasons, pinging the first router 14, 16 beyond the access point AP is preferable). The start of each stage implies the successful completion of the previous one. Success or failure of steps is recorded in the field “AP_status” of the related access point object. These actions are performed by the function “check_interface”, also used by the immediate scan task, which is explained later.

The link and ping task 340 is awakened when the poll interval of an interface having no empty access point list and with higher priority than the one currently used expires. This is needed to allow vertical handovers towards higher priority interfaces. Optionally, it could be awakened for lower priority interfaces, so to enhance handover performance whenever a handover towards lower priority interfaces is needed. The choice of enabling or not the latter depends on user preferences and context restrictions (power conditions for example).

Once an interface able to offer Level-three connectivity is discovered and a vertical handover is desirable (i.e. the new interface has higher priority than the one currently in use), the link and ping task 340 raises a signal that awakens the vertical handover task. This essentially takes care of the network interface switching. Instead, if no interesting access points have been discovered, the task returns to an idle state.

The link and ping task 340 is preferably performed on an interface basis, which means that its scope is limited to a single interface and not to all existing interfaces. On the contrary, the immediate scan task (explained next) refers to all available interfaces and is intended for immediate connectivity recovery.

Immediate Scan 320

The immediate scan task 320 is awakened by the S_DISCONNECTED signal, which is raised by other tasks as soon as the network interface the mobile terminal MT is currently using does not provide connectivity to the server 12 any longer. This could happen for two reasons: 1) the hardware itself becomes unavailable; 2) either the link layer or the network layer connectivity breaks. In the first case, the task 320 is awakened by the hardware update task. In the second case it is awakened by the ping current interface task 350. Immediate scan 320 first checks for available access points AP on the same interface the mobile terminal MT was connected with, as the disconnection could only be a matter of IP subnet roaming and a simple DCHP request will do. If connectivity is not restored, immediate scan 320 checks for connectivity using lower priority interfaces. If a connected interface is found, immediate scan 320 awakens the vertical handover task and interface switch then occurs. On the contrary, if no interfaces are able to provide connectivity, the task 320 eventually ends up in a “no connectivity” alert and turns back to an idle state.

Ping Current Interface 350

This task 350 is responsible for current network interface failure detection, both at the link and the network layer. It regularly probes the server 12 with a ping request and it raises a S_DISCONNECTED signal as soon as the current interface does not provide Layer-three connectivity any longer. If the server 12 is reachable, this task 350 turns back to an idle state.

Vertical Handover (VH) 360

The vertical handover task 360 is awakened when a vertical handover is needed and a suitable successor interface has already been detected by the link and ping task 340 or the immediate scan task 320. The VH 360 takes care of interface switching and IP parameter inheritance. The task 360 makes the new interface operational and communicates the event to processes that may be interested in it. After vertical handover completion, it turns back to an idle state.

Both “link and ping” and “immediate scan” tasks make use of the “check_interface” function, which is now explained in detail. Its role is to check layer two and layer three connectivity of a given interface. All access points AP belonging to the selected interface are first checked for layer two connectivity, and proper flags are set accordingly in the objects that describe each analyzed access point (link available/not available). If an access point AP₁₋₃ is found to provide link layer connectivity, IP connectivity is then checked. First, a DHCP request is made over the interface in order to gain a valid IP address from the bearer's infrastructure. If no IP address is given, the access point AP₁₋₃ is not suitable for communication. On the contrary, if an IP address is given, the last stage begins. This involves checking IP connectivity by pinging the server 12 and waiting for a response. If no response is given within a preset timeout, the access point AP₁₋₃ is not suitable for connection, otherwise the entire interface is said to be connected and marked as such. In this case the function exits successfully. If one of the described stages (link connection, DHCP request and pinging) fails, the function repeats the procedure for the next access point AP₁₋₃ in the list. If the list is completely scanned and no suitable access point AP₁₋₃ has been found, the interface is said to be disconnected and the function exits unsuccessfully.

At each, stage success or failure for a given access point AP₁₋₃ is recorded and cached so to speed up future scans by querying first the access points AP₁₋₃ with the higher number of successful stages. In fact, before scanning begins, the access point list AP₁₋₃ is sorted by degree of knowledge and by number of previously succeeded stages. First are placed registered access point points AP₁₋₃ with three succeeded stages, then cached access points AP with three succeeded stages. Then, all registered access points AP are sorted by number of succeeded stages and eventually all access points AP₁₋₃ are so cached.

It may also be the case that if some cached access point AP₁₋₃ retains a predetermined number of succeeded stages, e.g. less than three for a defined number of calls, its scanning will not be performed any more and it will be marked as “unavailable” for future scans. The same thing preferably happens to access points AP₁₋₃ that have explicitly rejected connection attempts.
The check_interface function has the following prototype:
Int check_interface(struct NetworkInterface* nic, int mode);
Its arguments are a pointer to a “NetworkInterface” class and a “mode”.
   The “NetworkInterface” (see FIG. 3, 202) class contains the description of a single network interface, while the mode indicates whether the function has to check for all available access points AP₁₋₃ associated with the interface or has to exit as soon as a usable access point AP₁₋₃ has been found. The first mode is used by the “link and ping task” 340, the second mode is used by the “immediate scan” task 320, where the crucial thing is finding out immediately a usable access point AP₁₋₃.

### Embodiments

The invention is particularly relevant to devices/nodes which are often moveable, hence referred to herein generically for convenience as mobile terminals MT, and that are equipped with two or more network interfaces. This includes portable computers, handheld devices and high-level cellular phones. The solution is intended to run at the mobile terminal MT only, and no assumptions are made on the bearers' infrastructures with exception of the requirement for ordinary network auto-configuration services (DHCP, BOOTP, PPP and similar). Possible fields of utilization include office environments. The proposed solution automatically switches between the wired Local Area Network and the Wireless domain when the user undocks his/her laptop for example. Methods of the present invention may be implemented in software and executed on a computing device, e.g. a portable computer, a handheld devices such as a PDA or a cellular phone which includes a digital computing device such as a microprocessor, an ASIC having computing functionality or a programmable digital logic element such as a programmable gate array, a Programmable Logic Array (PLA), a Programmable Array Logic (PAL) or a Field Programmable Gate Array (FPGA). Such software may be supplied in the form of a computer program in executable form stored on a data carrier such as a CD-ROM, a diskette, magnetic tape as well known to the skilled person.

With regard to mobile environments, the present invention can maintain connectivity when the user moves between different contexts. For example, connectivity is not dropped when the user exits his/her home or office wireless local area network by attaching to a cellular bearer.

The present invention solves the problems of manual network scan, choice and configuration. Available network interfaces are automatically sorted, e.g. in order of user's preferences, which could take into account bandwidth, costs and power consumption. In any case, given the profile of usage, the software will automatically decide on the best available interface.

The present invention falls in the middleware field of wireless connectivity, which is an area that will play an increasingly important role in the future. Among further differentces and advantages of the present invention is the provision of context awareness in the process of wireless network scanning and consequent network interface selection in a mobile terminal MT.

While the present invention has been particularly shown and described with respect to a preferred embodiment, it will be understood by those skilled in the art that changes in form and detail may be made without departing from the scope and spirit of the invention.

Glossary

Access Point: a device that provides wireless connectivity to a backbone. It could be either a layer 2 device (bridge) or a network layer device (access router).
Bridge: a device that forwards frames at layer two.
Router: a device capable of computing routes and forward packets at the network layer.
DHCP: Dynamic Host Configuration Protocol. An IETF standard protocol that configures automatically IP and DNS parameters of a host that connects to an IP network.
BOOTP: Boot Protocol. Provides DHCP similar facilities.
PPP: Point to Point Protocol. An IETF standard protocol that provides communication between two hosts over a serial line. It also offers IP parameters auto configuration.

1) A wireless client device for use in an Internet Protocol (IP) compatible communications network, said client device (MT) being adapted to communicate with said network in accordance with one of a plurality of communications standards (BT, IEEE802.11, GPRS) and to make a selection for connection to said network from among a plurality of network interfaces (AP₁₋₃), said device (MT) being arranged in use to make a said selection automatically and according to a predetermined network interface selection policy (NISP) implemented in said client device.

2) A client device according to claim 1, wherein a said network interface selection policy (NISP) is selected for implementation by user intervention or by said client device (MT) itself from among a predefined set of said selection policies stored therein.

3) A client device (MT) according to claim 1, wherein a said network interface selection policy (NISP) includes a consideration of at least one of location or context awareness, preferably including a mobility parameter indicative of whether a said location or context is dynamic or static and/or an indication of how such information has been gathered.

4) A client device according to claim 1, wherein said client device (MT) is adapted to change automatically between network interface selection policies (NISP) under predetermined circumstances, authority to make a said change preferably being provided by a user and/or preferably being notified to a user.

5) A client device according to claim 1, wherein said client device (MT) is adapted to test for the availability of one or more of said network interfaces (AP₁₋₃), preferably by periodically performing a scan of available interfaces.

6) A client device according to claim 1, wherein said client device (MT) is adapted to pre-connect to a said interface (AP₁₋₃) selected by a said network interface selection policy (NISP), so as to test the availability of said interface in advance of performing a handover thereto from a currently connected interface (AP₁₋₃).

7) A client device according to claim 1, wherein said network interfaces are controlled by a multi-standard enabled wireless adaptation layer (M-WAL) implemented in an operating system of said client device (MT).

8) A client device according to claim 1, wherein a plurality of said interfaces (AP₁₋₃) are assigned a priority for implementation in a said network interface selection policy (NISP), a said priority preferably being changeable in said client device (MT) and more preferably being dynamically changeable to reflect current status of said interface.

9) A client device according to claim 1, wherein said client device (MT) stores information relating to access points (AP₁₋₃) currently available and/or previously visited.

10) A client device according to claim 1, wherein said client device (MT) is adapted to monitor network interface (AP₁₋₃) availability substantially continuously and preferably keeps updated a stored list of available said interfaces.

11) A client device according to claim 1, wherein a switch between said interfaces (AP₁₋₃) is performed by said client device (MT) in the event that a stronger or higher priority interface becomes available or in the event that a connection to a network (BT, IEEE802.11, GPRS) that uses a current said interface (AP₁₋₃) is lost.

12) A client device according to claim 1, wherein said client device (MT) is adapted to check, at least periodically, the availability of one or more access points (AP₁₋₃) neighboring a currently connected access point (AP₁₋₃).

13) A client device according to claim 1, wherein a said network interface selection policy (NISP) includes consideration of at least one of usage cost, bandwidth availability, received signal strength, link quality, link availability, signal-to-noise ratio, power consumption or user intervention.

14) A client device according to claim 1, wherein a said communications standard comprises one of Ethernet, IEEE802.11a, IEEE802.11b, Bluetooth™, GPRS, and GSM.

15) A method of performing communication in an Internet Protocol (IP) compatible network, the method including:
a) connecting a client device (MT) to said network in accordance with one of a plurality of communications standards (BT, IEEE802.11, GPRS); and
b) changing automatically between said communications standards under predetermined circumstances defined in a network interface selection policy (NISP) implemented in said client device.

16) A computer program product for executing a method according to claim 15 when executed on a computing device.

17) A data carrier having the computer program product of claim 16 encoded thereon as an executable program.
